(19) United States
(12) Patent Application Publication
(10) Pub. No.: US 2026/0265939 A1
(43) Pub. Date: Sep. 10, 2026

(54) Electrolyser System

(71) Applicant: Ceres Intellectual Property Company Limited, Horsham, West Sussex (GB)

(72) Inventor: Hacib Ben Aissa, Horsham, West Sussex (GB)

(21) Appl. No.: 19/164,363

(22) PCT Filed: Mar. 13, 2024
(86) PCT No.: PCT/GB2024/050670

§ 371 Date: Sep. 11, 2025

(30) Foreign Application Priority Data
Mar. 15, 2023 (GB) 2303777.3

(51) Int. Cl. C25B 15/08; B01D 53/26; C25B 1/042; C25B 9/67; F01D 15/00

(52) U.S. Cl. CPC C25B 15/08; B01D 53/265; C25B 1/042; C25B 9/67; F01D 15/00; B01D 2257/80

(57) ABSTRACT

The present invention relates to an electrolyser system (10) comprising at least one electrolyser (20), the electrolyser (20) comprising at least one steam inlet (41) and at least one off-gas outlet (38; 39), and a turbocharger (62) for compressing off-gas from the electrolyser (20). The turbocharger (62) comprises a drive fluid inlet, a drive fluid outlet, a compression fluid inlet, a compressed fluid outlet, a compressor (13) and a turbine (12). The turbine (12) is configured to drive the compressor (13). The drive fluid outlet of the turbocharger (62) is fluidically connected to the at least one steam inlet (41) of the electrolyser (20). The at least one off-gas outlet (38; 39) of the electrolyser (20) is fluidically connected to the compression fluid inlet of the turbocharger (62). The system (10) can further can comprise a steam source fluidically connected to the drive fluid inlet of the turbocharger (62) for powering the turbine (12) using pressurised steam.

The present invention relates to an electrolyser system, and preferably a solid oxide electrolyser system, for producing compressed hydrogen.

It is well known that an electrolyser cell (also sometimes known as a regenerative fuel cell) can be used to convert water into hydrogen and oxygen. The process is a relatively straightforward process, although it requires a supply of electricity.

Although the oxygen can be a valuable resource, the hydrogen is the main focus of the present invention. That is because the collection and the subsequent storage and/or distribution of the hydrogen is commonly known to be difficult or costly, yet if achieved, the resulting compressed hydrogen can be highly valuable as a fuel that can contribute towards achieving net zero or decarbonisation targets, either through combustion or the use of an electrolytic reaction in a fuel cell to recombine it with oxygen.

Most known hydrogen storage solutions are complex and expensive, due to the small size of the hydrogen particles, and their propensity to escape through the walls of conventional containers, and due to the need to compress them to great pressures, and/or to reduce their temperature to very low temperatures to liquefy the hydrogen. As a consequence, both the hydrogen storage containers and the filling equipment—in particular in respect of the processes and equipment required for compressing or liquefying the hydrogen ready for such storage or transportation—are costly to produce and use. For example, many hydrogen storage solutions require extremely low temperatures—known as cryogenic temperatures. Further, most hydrogen storage solutions require large levels of externally supplied energy—both to operate the electrolyser and to generate the high pressures and low temperatures required for liquefying (or sufficiently compressing) the hydrogen ready for loading into suitable storage vessels.

The present invention seeks to provide a system for the compression of hydrogen that depends less upon external energy demands.

### STATEMENTS OF INVENTION

According to a first aspect of the present invention there is provided an electrolyser system comprising:
a. at least one electrolyser, the electrolyser comprising at least one steam inlet and at least one off-gas outlet; and
b. a turbocharger for compressing off-gas from the electrolyser;
wherein:
the turbocharger comprises a drive fluid inlet, a drive fluid outlet, a compression fluid inlet, a compressed fluid outlet, a compressor and a turbine,
the turbine is configured to drive the compressor;
the drive fluid outlet of the turbocharger is fluidically connected to the at least one steam inlet of the electrolyser; and
the at least one off-gas outlet of the electrolyser is fluidically connected to the compression fluid inlet of the turbocharger.

In such a way, higher delivery pressures can be achieved while enabling hydrogen generating systems to operate at, or near, atmospheric pressures.

In a typical configuration, the electrolyser system comprises a steam source such as a steam generator. The steam source or the steam generator is fluidically connected to the drive fluid inlet of the turbocharger for powering the turbine using pressurised steam. The steam may be supplied by the steam generator or an external source of steam, and is supplied at a pressure that exceeds the operating pressure of the electrolyser. Due to the higher pressure of the steam, the steam can power the turbocharger.

The steam, after powering the turbine, can then pass out of the turbine, via the drive fluid outlet, and into the electrolyser, via the steam inlet, as at least a partial water source for the electrolyser.

In some embodiments the electrolyser system comprises a heat exchanger adapted to cool the off-gas prior to entering the compressor.

In some embodiments the electrolyser system comprises a collection chamber for collecting water from the off-gas. This might be before, as or after it is compressed by the turbocharger.

In some embodiments the turbocharger's compressed fluid outlet is fluidically connected to the collection chamber (i.e. the collection chamber is downstream of the turbocharger).

In some embodiments the collection chamber has a fluid input that is fluidically connected to the compressed fluid outlet of the turbocharger.

In some embodiments the collection chamber has a compression fluid outlet that is fluidically connected to the compression fluid inlet of the compressor (i.e. the collection chamber is upstream of the turbocharger).

In some embodiments a steam generator is fluidically connected at least to the collection chamber. This then allows the collected water to provide at least a partial supply of water for the steam generator. The steam generator can then be the source of steam to power the turbine using steam at least partially derived from water from the collection chamber. For example, the electrolyser system may further comprise a steam generator, and a collection chamber is fluidically connected to the outlet of the steam generator to collect condensate from the steam when it exits the steam generator.

With the present invention, steam generated as a result of the steam generator (which will be at an elevated pressure versus the pressure of the off-gas at the off-gas outlet, and thus can be referred to as “high pressure” steam) can be supplied to the turbine of the turbocharger. The energy present in the high pressure steam is used to turn the turbine. The turbine is in turn connected to the compressor. The turbine thus powers the compressor, for example by driving a compressor wheel or other mechanical compression device. The compressor can thus then compress the off-gas gas, such as hydrogen, which before compression was at a relatively lower pressure than the generated steam, and thus can be referred to as “low pressure off-gas”. That low pressure off-gas will have been generated as a result of the electrolytic reaction of the electrolyser.

The off-gas is thus compressed to a relatively higher pressure versus that low pressure off-gas, and can thus be referred to as “high pressure off-gas. This high pressure off-gas can then be collected in storage vessels or otherwise distributed for downstream use.

Furthermore, with the optional collection chamber, water that is condensed out of the low pressure off-gas before, during, or after that off-gas is compressed by the turbocharger, is collected in the collection chamber and can be subsequently converted back into steam, which, in turn, is used to power the turbine and feed into the electrolyser again to provide a source fluid (water) for the electrolytic reaction therein.

This recirculation of the waste water (from the off-gas) increases the efficiency of the system by eliminating the need for replacement of the whole water supply after it has been passed through the electrolyser—instead the portion of the water not split by the electrolyser can be recirculated back through the electrolyser.

In some embodiments the electrolyser operates at a pressure at or in excess of atmospheric pressure, but at a pressure of less than 0.5 barg (gauge pressure).

In other embodiments the electrolyser operates at a pressure at or in excess of 0.5 barg (gauge pressure). Preferably it operates at a pressure of no more than 3 barg, or more preferably no more than 2 barg.

In some embodiments the system comprises a pump configured to deliver water to the steam generator. In some embodiments the pump is configured to deliver water condensed out of the off-gas from the electrolyser.

In some embodiments a collection chamber is provided after the steam generator to collect condensate from the steam when it exits the steam generator. This collection chamber may be a second collection chamber of the system.

In some embodiments the electrolyser comprises at least one electrolyser cell. Electrolyser cells are also sometimes known as fuel cells or regenerative fuel cells.

Typically the at least one electrolyser cell is part of a stack of electrolyser cells. There may be one or more stacks in the electrolyser.

The or each fuel cell may comprise an anode, a cathode and an electrolyte. However, some stacks may additionally comprise dummy cells (e.g. without an electrolyte).

In some embodiments, the or each electrolyser cell has an operational stack temperature in excess of 400 degrees C.

In some embodiments the at least one electrolyser cell is a solid oxide electrolyser cell, i.e. the electrochemically active region is a solid oxide. A solid oxide electrolyser cell (SOEC) typically operates in the 400-900 degrees C. range, or for some chemistries, 400 to 700 degrees C., or more particularly in the 450-650 degrees C. temperature range. Such electrolyser cells may be referred to as an intermediate-temperature solid oxide electrolyser cell, or IT-SOEC.

There are many possible forms of SOEC, using different electrochemically active electrolyte chemistries. For example, three well known electrolyte materials are yttria-stabilized zirconia (YSZ), scandia stabilized zirconia (ScSZ) and gadolinium doped ceria (GDC or CGO).

Due to the temperature of a SOEC (usually in excess of 400 degrees C.), the hydrogen always vents in a mixture with steam, and thus it was perceived to be difficult to compress the vented hydrogen without first passing it through a drying process. The present inventors, however, realised that the drying step can be automated as the water condenses out of the mixture as it is compressed, leaving behind substantially pure hydrogen for collection and distribution or use.

In some embodiments the electrolyser cell system comprises a high temperature electrolyser cell with an operational stack temperature between 750 degrees C. and 1100 degrees C.

The present invention also provides a method of operating an electrolyser system, the electrolyser system comprising:
a) at least one electrolyser, the electrolyser comprising at least one steam inlet and at least one off-gas outlet, the electrolyser having an operating pressure; and
b) a turbocharger for compressing off-gas from the electrolyser, the turbocharger comprising a drive fluid inlet, a drive fluid outlet, a compression fluid inlet, a compressed fluid outlet, a compressor and a turbine,
wherein:
steam at a supply pressure that is higher than the operating pressure of the electrolyser is provided to the drive fluid inlet of the turbocharger to power the turbine, which turbine is configured to drive the compressor;
the drive fluid outlet of the turbocharger is fluidically connected to the at least one steam inlet of the electrolyser, whereby the steam then exits the turbine and enters the electrolyser at a reduced pressure compared to its supply pressure; and
the at least one off-gas outlet of the electrolyser is fluidically connected to the compression fluid inlet of the turbocharger, whereby off-gas from the electrolyser fees to the turbocharger for compression by the turbocharger.

In some embodiments the steam is supplied by a steam generator that is a part of the electrolyser system.

The electrolyser system may be as defined above.

In some embodiments the method comprises at least one collection chamber for collecting distilling or condensing water.

In some embodiments collected water from the one or more collection chamber provides at least a partial supply of water for a steam generator that is a source of steam to power the turbine.

In some embodiments the electrolyser operates at a pressure at or in excess of atmospheric pressure, but at a pressure of less than 0.5 barg (gauge pressure).

In some embodiments the electrolyser operates at a pressure at or in excess of 0.5 barg but at a pressure of no more than 3 barg.

In some embodiments the heat of the off-gas from the electrolyser is recovered by at least one heat exchanger before entering the compressor.

In some embodiments the method comprises collecting water condensed as a result of the heat recovery by the heat exchanger.

Condensed water following this cooling may be recycled into the water source for the steam generator.

In some embodiments hydrogen is vented from a first side of the electrolyser (or a first side of the or each electrolyser cell) and oxygen is vented from a second side of the electrolyser (or a first side of the or each electrolyser cell of the electrolyser) to provide a hydrogen output and an oxygen output from the electrolyser. The oxygen and the hydrogen may be collected such that both hydrogen and oxygen is beneficially produced and collected, or just the hydrogen might be collected (or just the oxygen).

Typically the hydrogen output is on a cathode side of the electrolyser (or of the or each electrolyser cell of the electrolyser). Hydrogen thus vents on the cathode side.

Typically oxygen instead vents on an anode side of the electrolyser (or of the or each electrolyser cell of the electrolyser).

In some embodiments the electrolyser has an operating temperature in excess of 200 degrees C., in excess of 300 degrees C., or more usually in excess of 400 degrees C. Due to the operating temperature of such electrolysers being well above 100 degrees C., the hydrogen always vents in a mixture with steam. As mentioned above, such an off-gas was perceived to be difficult to compress without first passing it through a drying process. The present inventors, however, realised that the drying step can be automated as the water condenses out of the mixture as it is compressed, leaving behind substantially pure hydrogen for collection and distribution or use.

In some embodiments the off-gas released from the electrolyser at a first pressure passes through the compressor such that it exits the compressor at a relatively higher pressure.

In some embodiments there are two off-gases, and only one is passed through the turbocharger's compressor.

In some embodiments the off-gas to be compressed is hydrogen-enriched steam.

In some embodiments the waste heat from the electrolyser operates as an at least a partial heat source for the steam generator. In some embodiments the system instead or additionally comprises one or more external heat or power source for powering the steam generator, or one or more heater.

In some embodiments the heat from the exhaust steam (the second off-gas supply of the electrolyser) can be recovered via a heat exchanger and used to heat the steam generator.

In some embodiments the system is configured such that steam exiting the turbine passes through a third heater, and/or through a heat exchanger that draws heat from the electrolyser. Instead, or additionally, heat from the electrolyser can be recycled via heat exchangers to a sweep flow fluid and/or to a water or steam source for the electrolyser, i.e. to source fluids for the electrolyser. In some embodiments one or more heat exchanger connects that heat directly to a body of the electrolyser. These configurations can serve to help maintain a desired operational temperature for the electrolyser.

In some embodiments the steam generator is configured such that steam exiting the steam generator is at a higher pressure than the water entering the steam generator. Thus, in some embodiments the system is configured such that steam from the steam generator is at a relatively higher pressure than the off-gas from the electrolyser, and the steam from the steam generator passes through the turbine before entering the at least one electrolyser, the energy from the steam's pressure rotating the turbine which in turn rotates the compressor, thus pressurising the off-gas.

In such an embodiment, as the steam exits the turbine—through the drive fluid outlet, it will have been reduced in pressure by the turbine and thus can enter the electrolyser at a relatively lower pressure than that at which it enters the turbine. This ensures that the electrolyser can remain at a near atmospheric pressure internally (for example around 0-3 barg, preferably 0.5 to 1 barg, more preferably approximately 0.5 barg), which allows a simplified construction for the electrolyser.

In some embodiments the collection chamber collects condensed water from the now pressurised off-gas stream (after or as it passes through the compressor) and the system or the compressor has a pressurized off-gas outlet for distribution of the pressurized off-gas (usually hydrogen) elsewhere—e.g. for further compression, to a pressure vessel or to a delivery pipeline.

In some embodiments any water collected in the collection chamber from the pressurised off-gas passes through a heat exchanger in the steam generator.

In some embodiments the water is vaporised in the heat exchanger or steam generator to form steam at a pressure above atmospheric pressure.

In some embodiments, water condenses out of the off-gas mixture (usually hydrogen and steam) due to cooling of the mixture, whereas in the other embodiments it condenses due to pressurising the mixture, although it can also be a combination of the two. It is also to be observed that collection of, and/or re-circulation of, the condensed water is optional.

In some embodiments a second collection chamber is provided after the steam generator to collect condensate, or non-vaporised water, from the steam when it exits the steam generator.

In some embodiments the condensate is recycled through the steam generator for example via a pump.

In some embodiments the steam exiting the steam generator is superheated steam.

In other embodiments the steam is subsequently superheated by a further heater or heat exchanger before being fed into the turbine of the turbocharger. It is preferred that superheated steam is fed to the turbine to increase the efficiency thereof.

### BRIEF DESCRIPTION OF DRAWINGS

The present invention will now be described in further detail, purely by way of example, with reference to the accompanying drawings in which:

FIG. 1 schematically shows a first embodiment of an electrolyser system in accordance with the present invention;

FIG. 2 schematically shows a typical electrolyser cell, multiples of which may be stacked in a stack, is an electrolyser of the electrolyser system;

FIG. 3 schematically shows a second embodiment of an electrolyser system in accordance with the present invention;

FIG. 4 schematically shows a third embodiment of an electrolyser system in accordance with the present invention; and

FIG. 5 schematically shows a fourth embodiment of an electrolyser system in accordance with the present invention.

The coupling of a turbocharger 62 to an electrolyser allows for the electrolyser 20 to be operated near (but preferably still above) atmospheric pressure, while producing significantly higher pressure off-gasses (notably hydrogen). This means it is possible to use a simpler electrolyser construction which is less susceptible to leakage.

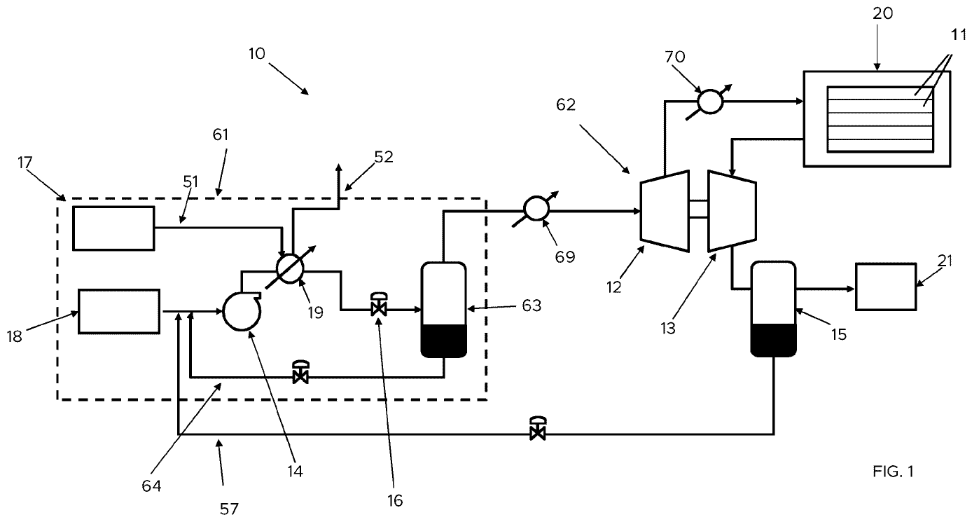

Referring first to FIG. 1, a first embodiment of an electrolyser system 10 is shown. It uses steam generated by a steam generator 61 and an electrolyser 20 to power a turbo charger 62, while also producing hydrogen for compression by the turbocharger 62.

In this embodiment, water (preferably deionised water from a deionized water source 18) is pumped through a first heat exchanger 19 at high pressure, such as at 10-15 barg. A pump 14 can be used for this purpose. The first heat exchanger 19 is supplied with heat from an external heat source 17 (which may at least partially be heat from the electrolyser 20) at an external heat in line 51 and that heat is used to convert the water into high pressure steam. Excess heat 52 may be produced, which could be used to heat the electrolyser 20 or in another process. The high-pressure steam then passes out of the heat exchanger 19, past a pressure regulator 16 and through an optional collection chamber 63 to a second heat exchanger 69. That second heat exchanger is also optional, but can be used to superheat the steam, for example if not already superheated by the first heat exchanger 19.

It is common knowledge that steam when increased to a high enough pressure will at least partially condense out into water. This is due to the temperature of vaporisation of water decreasing with increasing pressure. Thus, by placing collection chamber 63 between the first and second heat exchangers 19, 69 it can collect any condensed water.

In this embodiment the collection chamber 63 is configured for pumping the water back through the first heat exchanger 19 by way of a condensed water recovery line (or a recirculation line) 64 that feeds the water back through the pump 14.

Superheating of steam is a process that is well known in the art. It involves increasing the temperature of the steam above its saturation point at constant pressure. This is done to reduce the risk of damage or erosion to the internal surfaces of the system through which the steam passes, such as turbine blades of a turbine of the turbo charger 62 or the surfaces inside the electrolyser. In particular it protects the cathode of the electrolyser cells, which may crack if exposed to water in liquid form.

In the embodiment of FIG. 1, the superheated high pressure steam passes through the turbine 12 of the turbocharger 62, which turbine 12 is connected to a compressor 13. The energy present in the steam by virtue of its pressure can then be used to rotate the turbine 12, and as a result it also powers the compressor 13. Thus, as a result of passing through the turbine 12, the turbo charger 62 is powered. However, this reduces the pressure and/or temperature of the superheated steam so the steam may then be subsequently passed through an optional third heat exchanger 70 to raise the temperature to the operating temperature of the electrolyser if necessary before it passes into the electrolyser 20.

It should be noted that the compressor 13 may be a centrifugal compressor directly connected to the shaft of the turbine (steam expander) 12, or another type of mechanically driven compressor. For example, it could take the form of a reciprocating compressor where the turbine shaft drives a cam to provide a reciprocating motion. Furthermore, the compressor 13 may only be powered in part by the turbine 12, and ‘top up’ power may be supplied to increase the compression ratio.

Once in the electrolyser 20, which is operated by an external electricity supply the steam is electrolyzed within electrolyser cells 11 of the electrolyser to generate hydrogen and oxygen. These gases can vent from the electrolyser, with the hydrogen venting on a cathode side thereof along within any remaining steam—as a mixture of hydrogen and steam. The oxygen instead vents from an anode side of the electrolyser, and thus is separate from that mixture.

The vented gases exiting the electrolyser are also known as off-gases.

Typically the electrolyser 20 operates at a pressure at or in excess of atmospheric pressure, but at a pressure of less than 0.5 barg (gauge pressure), so the off-gases likewise vent at that pressure. This pressure is too low for storage or distribution—particularly in respect of hydrogen, so the present invention is configured to pass that hydrogen to the compressor 13 of the turbocharger 62.

Although this embodiment operates at a pressure at or in excess of atmospheric pressure, but at a pressure of less than 0.5 barg, in other embodiments the electrolyser 20 may instead operate at a pressure at or in excess of 0.5 barg, although in typical commercially available electrolysers, the operating pressure is maintained at a level of no more than 3 barg, or more commonly no more than 2 barg.

The mixture of hydrogen and excess steam exiting at the cathode of the electrolyser 20 may be termed ‘wet hydrogen’. This mixture, as mentioned above, passes out of the electrolyser 20 and through the compressor 13 of the turbocharger 62. As the compressor 13 is being powered at least in part by virtue of its connection to the turbine 12, that passage of the off-gas through the compressor 13 compresses the wet hydrogen to increase its pressure.

After being pressurised by the compressor 13, the pressurised mixture is passed through a further optional collection chamber 15 fluidically connected to the compressed fluid outlet of the turbocharger 62 to collect any condensed water from that mixture prior to the off gas being stored or used downstream 21. In this embodiment, the collected water is then able to be pumped it back through to the first heat exchanger 19 via a further condensed water recovery line (or a recirculation line) 57, that likewise feeds the water back through the pump 14.

This further optional collection chamber may hereinafter be referred to as a first collection chamber 15, and the previously described collection chamber 63 as a second collection chamber 63.

Pressurised steam can thus be used to run the turbocharger 62 to compress an off-gas released as a by-product of the electrolytic reaction of the electrolyser—preferably the hydrogen off-gas. Furthermore it can optionally condense out the steam in that mixture to dry the hydrogen ready for use elsewhere (or even by the electrolyser cells if useable also as fuel cells to generate electricity, rather than in their regenerative capacity). Solid oxide fuel cells manufactured by the applicant, Ceres Power®, can be used bi-directionally in this manner.

This utilization of the steam's pressure, and particularly the recirculation of the water, increases the efficiency of the overall electrolyser system 10. If the heat for the steam generator is available as a waste heat source, then this is even more efficient as that heat can be reutilized in this system 10.

Such an arrangement is particularly advantageous when a source of pressurized steam is readily available, for example as a by-product (or excess) of another industrial process such as in a refinery, or power plant; or from a hydrothermal source. In such cases, the steam generator 61 would not be present and simply replaced with a steam source. The collected water may be recycled into the external steam supply system or simply discarded.

The present invention can, for example, reduce the need for an additional stage of compression to pressurise the off-gas (hydrogen) for storage or for downstream use, for example either within the system (when used as a fuel cell rather than for regenerative purposes) or for external purposes. This partial compression may also ameliorate downstream handling requirements, leading to a simpler downstream system design.

Depending on the constraints in the design choice and/or operating requirements, different variables can be varied so as to control pressure at different points. Relevant factors relating to the control strategy include:
the ability to control the pressure of the steam inlet
the desire to maintain a constant internal electrolyser pressure. For example, the efficiency may deteriorate away from an optimum pressure
the expansion ratio of the expander of the turbocharger, and/or the turn-down ratio of the compressor. For example, the efficiency may deteriorate away from optimum conditions, or this may be fixed in an ‘off the shelf’ turbocharger.
the level of downstream compression required; this may influence the desired off-gas pressure
the utilization ratio; the relative flow rates of steam and hydrogen (and hence relative pressures) will be affected by the proportion of steam electrolysed to hydrogen and oxygen.

The below table indicates example operation conditions and advantages/considerations when controlling one variable by modifying another:

TABLE 1
Example system control scenarios

| | | | Expansion ratio of |
|---|---|---|---|
| Control below/ | Internal pressure of | | steam expander of |
| by varying right | the electrolyser | Inlet pressure of steam | turbocharger |
| Internal pressure | x | Allows for a | The source of |
| of the | | standard/fixed operation | steam may be |
| electrolyser | | of a turbocharger (for | dependent on an |
| | | example at optimum | external system |
| | | condition) | (such as a refinery) |
| | | | so this would be the |
| | | | only way of |
| | | | controlling the |
| | | | internal pressure of |
| | | | electrolyser |
| Expansion ratio | Allowing variability of | A turbocharger may | x |
| of steam | the internal pressure | have an ideal inlet | |
| expander of | of the electrolyser | pressure, which could be | |
| turbocharger | pressure could | controlled by the inlet | |
| | maintain optimum | steam pressure. | |
| | conditions for the | | |
| | turbocharger | | |
| Pressure of off- | Allows for the | Pressure of the steam | May be readily |
| gas | turbocharger to do | may be readily modified | modulated to |
| | less work by | to increase or decrease | maintain a desired |
| | maintaining a higher | the pressure of the off- | off-gas pressure |
| | stack pressure | gas | (potentially together |
| | | | with inlet steam |
| | | | pressure) |

In some embodiments the internal pressure of the electrolyser would have an optimum level (for example a maximum pressure before leakage becomes unacceptably high). In such cases, the inlet pressure of the steam and expansion ratio of the expander in the turbocharger (and the turn-down ratio of the compressor), can be varied to adjust the pressure of the off-gas.

For example, if the pressure of the steam is a certain level, the turbocharger must down-step this to the desired internal pressure of the electrolyser; the amount of this down-step defines the amount of compression of the off-gas (based on the turn-down ratio of the compressor).

In this first embodiment, the amount of deionized water from an external source 18 can be substantially reduced—only a part of the steam passing through the electrolyser is converted to hydrogen and oxygen, and thus recovering the remaining water by its condensation in the turbo charger 62 (due to decrease in temperature and increase in pressure) can allow recirculation thereof through the electrolyser system 10. Similarly, any liquid water arising or remaining after the pressurization of the steam in the first heat exchanger 19 (e.g. in the steam generator 61) can similarly be collected and recycled and heated by passing it back through a first heat exchanger 19 to generate more of the steam at high pressure.

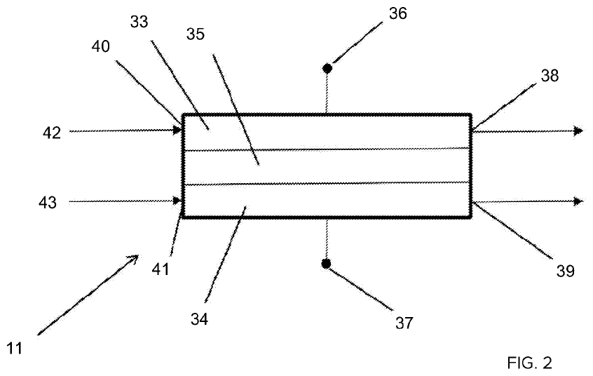

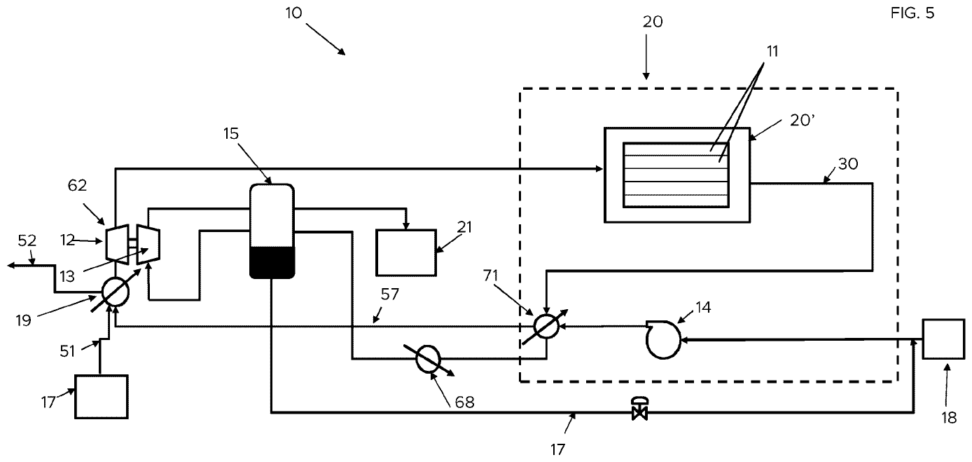

Referring next to FIG. 2, the basic structure and operation of a typical electrolyser cell 11 within the electrolyser 20 is shown by reference to one fuel/electrolyser cell 11 of a stack. It should be noted that other ancillary components related to the cell 11 are included in the electrolyser 20. These include heat exchangers, valves, sensors; FIG. 5 shows a partially expanded electrolyser 20 showing example ancillary components.

The electrolyser cell 11 comprises an anode 33, a cathode 34 and an electrolyte 35. Such a structure for an electrolyser cell 11 is well known in the art. Water—here in the form of steam 43 from a steam source—such as a steam generator—is passed over the cathode 34 via inlet 41 and hot air 42 is passed over the anode 33 via inlet 40. To power the electrolyser 20, an electric current/voltage is applied across the electrolyser cell 11 via electric terminals/connections 36, 37 at the anode and cathode sides of the electrolyser cell 11. These terminals may be positioned adjacent to one-another on one side of the stack, for example by extending one terminal using a bus bar. As a consequence, an electrolytic reaction occurs across the electrolyte 35, with oxygen ions passing across the electrolyte 35 from the cathode 34 to the anode 33, whereby some of the steam is broken down into hydrogen on the cathode side of the electrolyser cell 11 and oxygen at the anode side.

The oxygen can be extracted via an airflow or sweep flow provided by the hot air 42 for venting it out of an off-gas outlet 38 on the anode side of the electrolyser cell 11 as an oxygen enriched air. The hydrogen can be extracted and vented out of another off-gas outlet 39 on the cathode side of the electrolyser cell 11. This off gas may also contain steam, as the conversion of the steam into oxygen and hydrogen is usually only in respect of a proportion of the supplied steam. The hydrogen is thus vented as ‘wet’ hydrogen. Thus, the steam exiting the cathode side is hydrogen enriched, and the air exiting the anode side is oxygen enriched. Due to the operating temperature of the electrolyser cell 11—in the case of an SOEC usually in excess of 400 degrees C., those off-gases will be at a similar temperature to the operational temperature of the electrolyser cell 11.

Such operational characteristics of a SOEC are well known in the art but are beneficial for the present invention as the heat of the off-gases is able to be usefully used by the electrolyser system 10, rather than being wasted, for example to provide at least some of the heat for the steam generator 61.

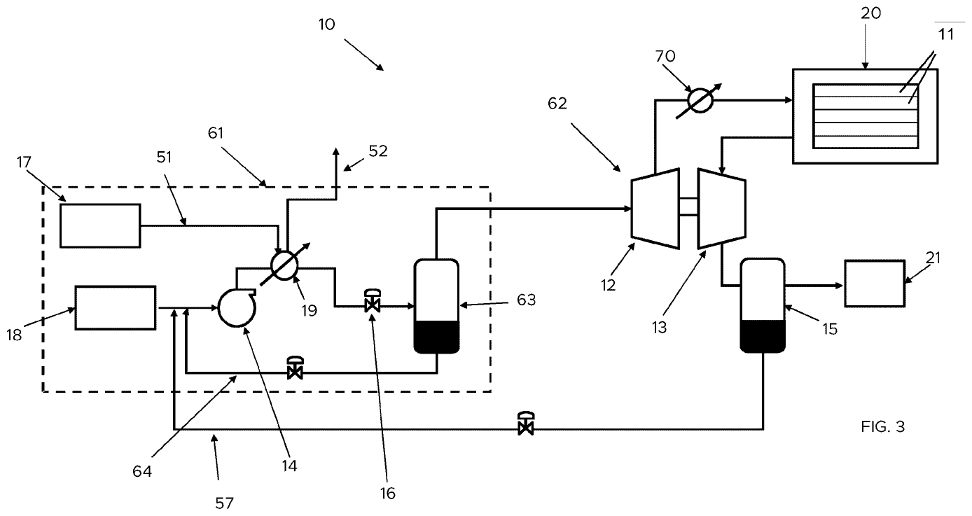

Referring next to FIG. 3, a second embodiment of the present invention is shown. As can be seen, this embodiment is schematically illustrated in an identical manner to that of FIG. 1, apart from heat exchanger 69 being omitted. It again uses steam generated by a steam generator 61 to power an electrolyser 62. Deionised water again passes through a first heat exchanger 19 in the steam generator 61 at high pressure and temperature, although in this embodiment it has an example temperature and pressure instead of 9 barg and 90 degrees C. This can again by driven by means of a pump 14. Furthermore, the heat exchanger 19 can be supplied with heat from an external source 17 and is used to vaporise the water at high pressure into steam at high pressure. However, in this embodiment, this first heat exchanger 19 achieves the superheating of the steam. In one example, the steam is at a temperature and pressure of 250 degrees C. at 9 barg, although alternative temperatures and pressures could instead be used to a similar effect. The second heat exchanger 69 of FIG. 1 is no longer necessary as the steam is already superheated, and thus it isn't shown to be present.

In each of these embodiments, further pressure regulators and pressure and temperature sensors can be provided. These can allow the system to be monitored by a control system and regulated to avoid excess peak pressures, or excessively low pressures.

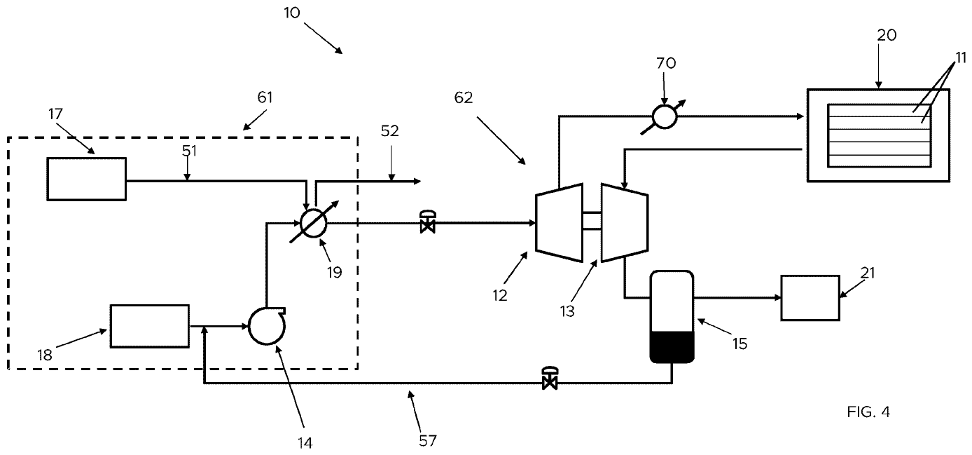

Referring next to FIG. 4, a third embodiment of the electrolyser system 10 is shown. It is similar to that of FIG. 3, but now the second collection chamber is also eliminated as the steam generator 61 is adapted to operate such that little or no liquid water remains at the outlet of the steam generator 61. As the system otherwise operates in the same manner as FIGS. 1 and 3, this embodiment need not be further discussed.

Referring next to FIG. 5, a fourth embodiment of the electrolyser system 10 is shown showing additional ancillary components within the electrolyser 20. Such components may be present in the systems of FIGS. 1, 3 and 4 within the electrolyser 20 to cool and dry the off gas prior to compression.

The embodiment of FIG. 5, like that of FIGS. 1, 3 and 4, uses steam generated by the steam generator 61 to power an electrolyser 20. The additional components shown are to remove at least some of the water prior to the off-gas being compressed, This reduces the amount of water condensing inside the compressor which may adversely affect the performance and damage the compressor.

As described above, steam passes through the electrolyser 20′ which includes electrolyser cells 11 and other ancillary components; a portion of the steam is split into oxygen and hydrogen—the electrolyser 20′ outputting at least wet hydrogen (a mixture of steam and hydrogen) for compression by the turbocharger 62. However, rather than venting straight into the compressor 13 of the turbo charger 62, the vented wet hydrogen is fed through a supply line 30 to a heat exchanger 71, where it is part-cooled. The excess heat can be used to heat a source of water which feeds the steam generator. In such a case, the heat exchanger 71 is a regenerative heat exchanger. It then passes through a second heat exchanger 68 to be further cooled and water is condensed out. This condensed water can be collected in a collection chamber 15. The hydrogen—now at least partially dried—is then be fed to the compressor 13 of the turbocharger 62. Further water collection into collection chamber 15 occurs to capture condensate following compression and is then passed for storage or downstream use 21.

Meanwhile the water that has been condensed out of the mixture is fed to the pump 14 for feeding back into the cycle. For this purpose, the water mixes with any required resupply of water from the water source 18 and is then passed through the pump 14. The pump 14 pumps the water back through the regenerative heat exchanger 71 to preheat it, before then repassing that water through a further first heat exchanger 19 to further heat it to convert it to steam. A source of heat 17 is also provided. This generates and pressurises the steam for passing through the turbine 12 of the turbocharger 62 to drive the compressor 13.

As the pressurised steam passes through the turbine 12 of the turbocharger 62, the energy in the pressurised steam is used to rotate the turbine 12 which is connected to the compressor 13, as described above with reference to FIGS. 1 and 3.

It should be appreciated that a second off-gas, in this case oxygen enriched air, is vented via a second supply line (not shown in the Figures).

Heat exchangers in the Figures which perform opposing operations (i.e. warming/cooling) may be combined as two sides of a single heat exchanger to increase the temperature difference and thus operate more efficiently.

The present invention has therefore been described above purely by way of example with reference to the accompanying drawings. It will be apparent to those of ordinary skill in the art that various modifications and variations can be made thereto without departing from the scope of the appended claims. For instance, features described as part of one embodiment can be used on another embodiment to yield a still further embodiment. Thus, it is intended that the present invention cover such modifications and variations as come within the scope of the appended claims. For example, while the description is focused on H2O electrolysis, it could be applied to CO2 electrolysis where CO is produced at the cathode and O2 at the anode. In such an implementation, CO2 would replace the steam input and CO would replace the hydrogen-enriched steam output.

1. An electrolyser system comprising:
a. at least one electrolyser, the electrolyser comprising at least one steam inlet and at least one off-gas outlet; and
b. a turbocharger for compressing off-gas from the electrolyser;
wherein:
the turbocharger comprises a drive fluid inlet, a drive fluid outlet, a compression fluid inlet, a compressed fluid outlet, a compressor and a turbine,
the turbine is configured to drive the compressor;
the drive fluid outlet of the turbocharger is fluidically connected to the at least one steam inlet of the electrolyser; and
the at least one off-gas outlet of the electrolyser is fluidically connected to the compression fluid inlet of the turbocharger.

2. The electrolyser system of claim 1, further comprising a steam source fluidically connected to the drive fluid inlet of the turbocharger for powering the turbine using pressurised steam.

3. The electrolyser system of claim 1 comprising a heat exchanger adapted to cool the off-gas prior to entering the compressor.

4. The electrolyser system of claim 1, further comprising a collection chamber for collecting water from the off-gas.

5. The electrolyser system of claim 4, wherein the collection chamber has a fluid input that is fluidically connected to the compressed fluid outlet of the turbocharger.

6. The electrolyser system of claim 4, wherein the collection chamber has a compression fluid outlet that is fluidically connected to the compression fluid inlet of the compressor.

7. (canceled)

8. The electrolyser system of claim 1, further comprising a steam generator, and a collection chamber is fluidically connected to the outlet of the steam generator to collect condensate from the steam when it exits the steam generator.

9-11. (canceled)

12. A method of operating an electrolyser system, the electrolyser system comprising:
a) at least one electrolyser, the electrolyser comprising at least one steam inlet and at least one off-gas outlet, the electrolyser having an operating pressure; and
b) a turbocharger for compressing off-gas from the electrolyser, the turbocharger comprising a drive fluid inlet, a drive fluid outlet, a compression fluid inlet, a compressed fluid outlet, a compressor and a turbine,
wherein:
steam at a supply pressure that is higher than the operating pressure of the electrolyser is provided to the drive fluid inlet of the turbocharger to power the turbine, which turbine is configured to drive the compressor;
the drive fluid outlet of the turbocharger is fluidically connected to the at least one steam inlet of the electrolyser, whereby the steam then exits the turbine and enters the electrolyser at a reduced pressure compared to its supply pressure; and
the at least one off-gas outlet of the electrolyser is fluidically connected to the compression fluid inlet of the turbocharger, whereby off-gas from the electrolyser fees to the turbocharger for compression by the turbocharger.

13. The method of claim 12, wherein the steam is supplied by a steam generator that is a part of the electrolyser system.

14. The method of claim 12, wherein the electrolyser system further comprises a steam source fluidically connected to the drive fluid inlet of the turbocharger for powering the turbine using pressurised steam.

15. The method of claim 12, comprising at least one collection chamber for collecting distilling or condensing water.

16. The method according to claim 15 wherein collected water from the one or more collection chamber provides at least a partial supply of water for a steam generator that is a source of steam to power the turbine.

17. The method of claim 12, wherein the electrolyser operates at a pressure at or in excess of atmospheric pressure, but at a pressure of less than 0.5 barg (gauge pressure).

18. The method of claim 12, wherein the electrolyser operates at a pressure at or in excess of 0.5 barg but at a pressure of no more than 3 barg.

19. The method of claim 12, wherein heat in off-gas from the electrolyser is recovered by at least one heat exchanger before entering the compressor.

20. The method of claim 19 comprising collecting water condensed as a result of the heat recovery by the heat exchanger.

21. The method of claim 12, wherein hydrogen is vented from a first side of the electrolyser and oxygen is vented from a second side of the electrolyser to provide a hydrogen output and an oxygen output from the electrolyser.

22. The method of claim 12, wherein off-gas released from the electrolyser is released at a first pressure and it passes through the compressor such that it exits the compressor at a relatively higher pressure.

23. (canceled)

24. The method of claim 12, wherein heat from an exhaust stream of the electrolyser is recovered via a heat exchanger and used to heat the steam.

25. The method of claim 12, wherein steam exiting the turbine passes through a heater, and/or through a heat exchanger that draws heat from the electrolyser.
